(19) United States
(12) Patent Application Publication
(10) Pub. No.: US 2009/0263675 A1
(43) Pub. Date: Oct. 22, 2009

(54) Alloy, Protective Layer for Protecting a Component Against Corrosion and/or Oxidation at High Tempertures and Component

(76) Inventor: Werner Stamm, Mülheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/084,077

(22) PCT Filed: Oct. 26, 2006
(86) PCT No.: PCT/EP2006/067802

§ 371 Date: Apr. 24, 2008

(30) Foreign Application Priority Data
Nov. 4, 2005 (EP) 05024112.4

(51) Int. Cl. B32B 15/04; C22C 30/00

(52) U.S. Cl. 428/621; 428/656; 420/588

(57) ABSTRACT

Known protective layers with a high Cr content form brittle phases which become even more brittle during use under the influence of carbon. The protective layer according to the invention has the composition 26% to 28% cobalt, 20% to 22% chromium, 7% to 8% aluminium, 0.5% to 0.7% yttrium and/or at least one equivalent metal from the group comprising scandium and the rare-earth elements, optionally silicon and/or rhenium and the rest made up of nickel.

### CROSS REFERENCE TO RELATED APPLICATIONS

This application is the US National Stage of International Application No. PCT/EP2006/067802, filed Oct. 26, 2006 and claims the benefit thereof. The International Application claims the benefits of European application No. 05024112.4 filed Nov. 4, 2005, both of the applications are incorporated by reference herein in their entirety.

### FIELD OF INVENTION

The invention relates to an alloy as claimed in the claims, to a protective layer for protecting a component against corrosion and/or oxidation at high temperatures as claimed in the claims and to a component as claimed in the claims.

The invention relates in particular to a protective layer for a component which consists of a nickel- or cobalt-based superalloy.

### BACKGROUND OF THE INVENTION

Large numbers of protective layers for metal components, which are intended to increase their corrosion resistance and/or oxidation resistance, are known in the prior art. Most of these protective layers are known by the generic name MCrAlY, where M stands for at least one of the elements from the group comprising iron, cobalt and nickel and the other essential constituents are chromium, aluminum and yttrium.

Typical coatings of this type are known from U.S. Pat. Nos. 4,005,989 and 4,034,142.

U.S. Pat. No. 6,280,857 B1 discloses a protective layer which discloses the elements cobalt, chromium and aluminum based on nickel and mandatory additions of yttrium, rhenium and silicon.

The endeavor to increase the intake temperatures both in static gas turbines and in aircraft engines is of great importance in the specialist field of gas turbines, since the intake temperatures are important determining quantities for the thermodynamic efficiencies achievable with gas turbines. Intake temperatures significantly higher than 1000° C. are possible when using specially developed alloys as base materials for components to be strongly heated, such as guide vanes and rotor blades, in particular by using monocrystalline superalloys. To date, the prior art permits intake temperatures of 950° C. or more for static gas turbines and 1100° C. or more in gas turbines of aircraft engines.

Examples of the structure of a turbine blade with a monocrystalline substrate, which in turn may be complexly constructed, are disclosed by WO 91/01433 A1.

While the physical loading capacity of the base materials so far developed for the components to be heavily loaded is substantially unproblematic in respect of possible further increases in the intake temperatures, it is necessary to resort to protective layers in order to achieve sufficient resistance against oxidation and corrosion. Besides sufficient chemical stability of a protective layer under the aggressions which are to be expected from exhaust gases at temperatures of the order of 1000° C., a protective layer must also have sufficiently good mechanical properties, not least in respect of the mechanical interaction between the protective layer and the base material. In particular, the protective layer must be ductile enough to be able to accommodate possible deformations of the base material and not crack, since points of attack would thereby be provided for oxidation and corrosion. The problem then typically arises that increasing the proportions of elements such as aluminum and chromium, which can improve the resistance of a protective layer against oxidation and corrosion, leads to a deterioration of the ductility of the protective layer so that mechanical failure is possible, in particular the formation of cracks, under a mechanical load conventionally occurring in a gas turbine.

### SUMMARY OF INVENTION

It is therefore an object of the invention to provide an alloy and a protective layer which has good high-temperature resistance to corrosion and oxidation, has good long-term stability and which is furthermore adapted particularly well to a mechanical load which is to be expected particularly in a gas turbine at a high temperature.

The object is achieved by an alloy as claimed in the claims and a protective layer as claimed in the claims.

It is another object of the invention to provide a component which has increased protection against corrosion and oxidation.

The object is likewise achieved by a component as claimed in the claims, in particular a component of a gas turbine or steam turbine, which comprises a protective layer of the type described above for protection against corrosion and oxidation at high temperatures.

Further advantageous measures are listed in the dependent claims.

The measures listed in the dependent claims may advantageously be combined with one another in any desired way.

The invention is based inter alia on the discovery that the protective layer exhibits brittle chromium-rhenium precipitates in the protective layer itself and in the transition region between the protective layer and the base material. These brittle phases, which are formed increasingly over time and with the temperature during use, lead during operation to very pronounced longitudinal cracks in the protective layer as well as in the layer-base material interface, with subsequent shedding of the protective layer. The brittleness of the precipitates is further increased by the interaction with carbon, which can diffuse into the protective layer from the base material or diffuses into the protective layer through the surface during a heat treatment in the furnace. The impetus to cracking is further enhanced by oxidation of these phases.

The effect of cobalt, which determines the thermal and mechanical properties, is also important in this case.

### BRIEF DESCRIPTION OF THE DRAWINGS

The invention will be explained in more detail below.

FIG. 1 shows a layer system with a protective layer,

FIG. 2 shows compositions of superalloys,

FIG. 3 shows a gas turbine,

FIG. 4 shows a perspective view of a combustion chamber and

FIG. 5 shows a perspective view of a turbine blade.

### DETAILED DESCRIPTION OF INVENTION

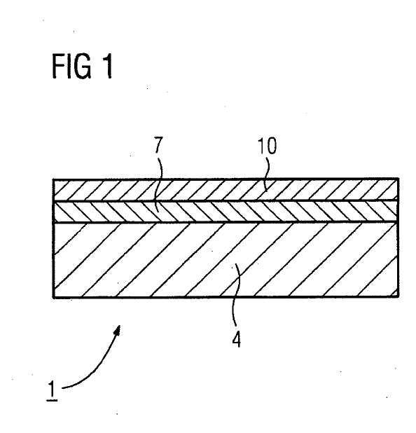

According to the invention, a protective layer 7 (FIG. 1) for protecting a component against corrosion and oxidation at a high temperature contains the following elements (in wt %):

from 26% to 28% cobalt (Co)

from 20% to 22% chromium (Cr)

from 7% to 9% aluminum (Al)

from 0.5% to 0.7% yttrium (Y) and/or at least one equivalent metal from the group comprising scandium (Sc) and the rare earth elements, remainder nickel (NiCoCrAlY).

The alloy optionally contains up to 2 wt % silicon.

The alloy may furthermore comprise up 11 wt % rhenium.

The advantageous effect of the element rhenium can thereby be utilized while preventing the brittle phase formation.

The alloy may optionally also comprise ruthenium. Ruthenium with a maximum proportion of 11 wt % may partially or fully replace the rhenium.

It is preferable to use only rhenium.

It is to be noted that the proportions of the individual elements are specially adapted with a view to their effects. If the proportions are dimensioned so that no chromium precipitates are formed, then advantageously no brittle phases are created during use of the protective layer so that the operating time performance is improved and extended.

This is achieved not only by a low chromium content but also, taking into account the effect of aluminum on the phase formation, by accurately dimensioning the aluminum content.

The choice of from 26 wt % to 28 wt % cobalt surprisingly improves the thermal and mechanical properties of the protective layer 7 significantly and superproportionally.

With good corrosion resistance, the protective layer 7 has particularly good resistance against oxidation and is also distinguished by particularly good ductility properties, so that it is particularly qualified for use in a gas turbine with a further increase in the intake temperature. During operation, embrittlement scarcely takes place since the layer comprises hardly any chromium precipitates, in particular no chromium-rhenium precipitates, which become embrittled in the course of use.

It is advantageous to set the proportion of aluminum at 8 wt % and to form of Al₂O₃ during coating with the alloy. The proportion of aluminum can therefore be kept low. It is likewise advantageous to set the proportion of yttrium or the at least one equivalent element from the group comprising scandium and the rare earth elements at 0.6 wt %. Certain variations are encountered owing to industrial mass production, so that yttrium contents of from 0.4% to 0.5% or from 0.7% to 0.8% are also used and likewise exhibit good properties.

It is particularly favorable to set the chromium content at about 21 wt %, the aluminum content at about 8 wt % and the cobalt content at about 27 wt %.

The alloy preferably contains no other elements besides the elements nickel, chromium, cobalt, aluminum, yttrium (Sc, rare earths).

Particularly good exemplary embodiments are:
1) Ni-27Co-21Cr-8Al-0.6Y
2) Ni-27Co-21Cr-8Al-0.6Y-1.5Si
3) Ni-27Co-21Cr-8Al-0.6Y-1.5Si—Re

The trace elements in the powder to be sprayed, which form precipitates and therefore represent embrittlements, play a likewise important role.

The powders are for example applied by plasma spraying (APS, LPPS, VPS, . . . ). Other methods may likewise be envisaged (PVD, CVD, cold gas spraying, . . . ).

The thickness of the protective layer 7 on the component 1 is preferably dimensioned at a value of between 100 μm and 300 82 m.

In this component, the protective layer 7 is advantageously applied onto a substrate 4 made of a nickel-based or cobalt-based superalloy.

The following composition in particular may be suitable as a substrate 4 (data in wt %):

From 0.1% to 0.15% carbon

from 18% to 22% chromium

from 18% to 19% cobalt

from 0% to 2% tungsten

from 0% to 4% molybdenum

from 0% to 1.5% tantalum

from 0% to 1% niobium

from 1% to 3% aluminum

from 2% to 4% titanium

from 0% to 0.75% hafnium

optionally small proportions of boron and/or zirconium, remainder nickel.

Compositions of this type are known as casting alloys under the references GDT222, IN939, IN6203 and Udimet 500.

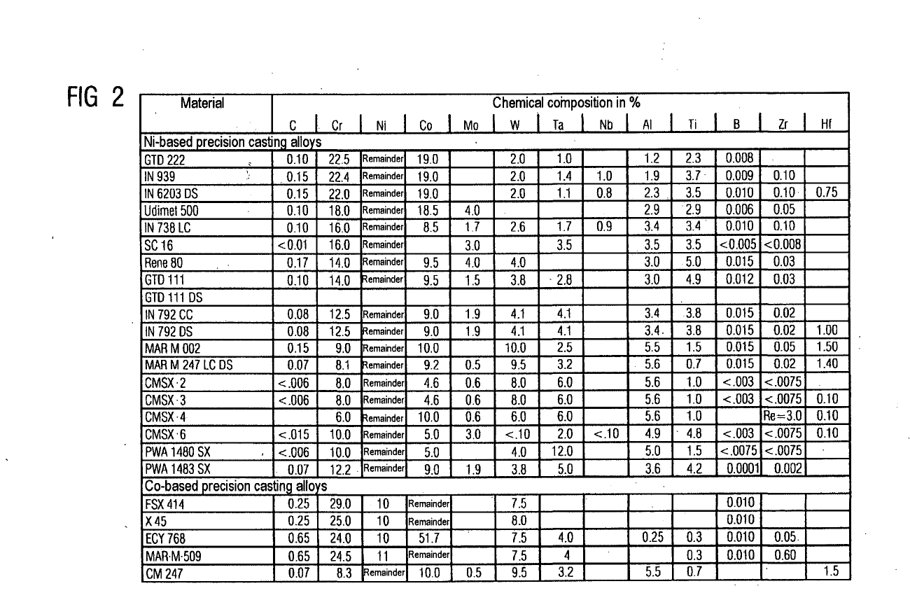

Other advantageous alternatives for the substrate 4 of the component are listed in FIG. 2.

The protective layer 7 is particularly suitable for protecting a component against corrosion and oxidation while the component is being exposed to an exhaust gas at a material temperature of about 950° C., or even about 1100° C. in aircraft turbines.

The protective layer 7 according to the invention is therefore particularly qualified for protecting a component of a gas turbine 100, in particular a guide vane 130, rotor blade 120 or other components, which are exposed to hot gas before or in the turbine of the gas turbine.

The protective layer 7 may be used as an overlay (the protective layer is the outer layer) or as a bondcoat (the protective layer is an interlayer).

FIG. 1 shows a layer system 1 as a component.

The layer system 1 consists of a substrate 4.

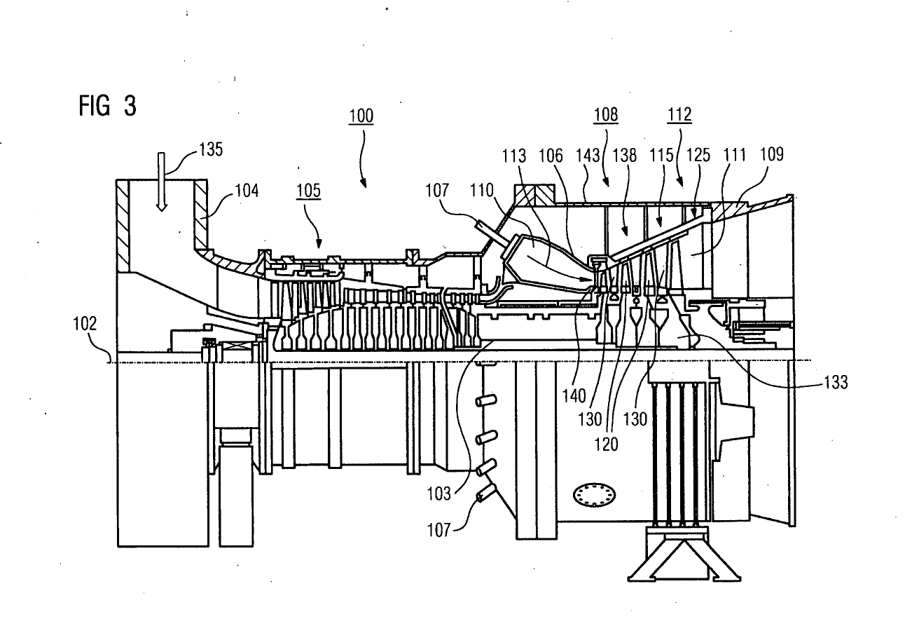

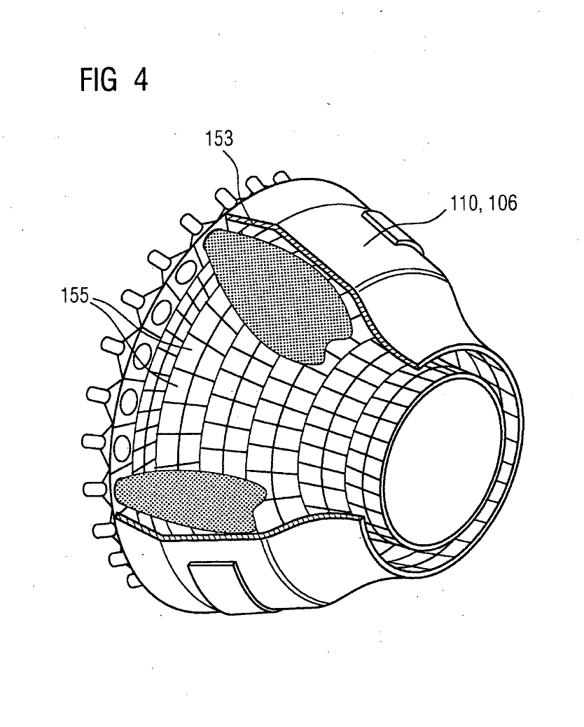

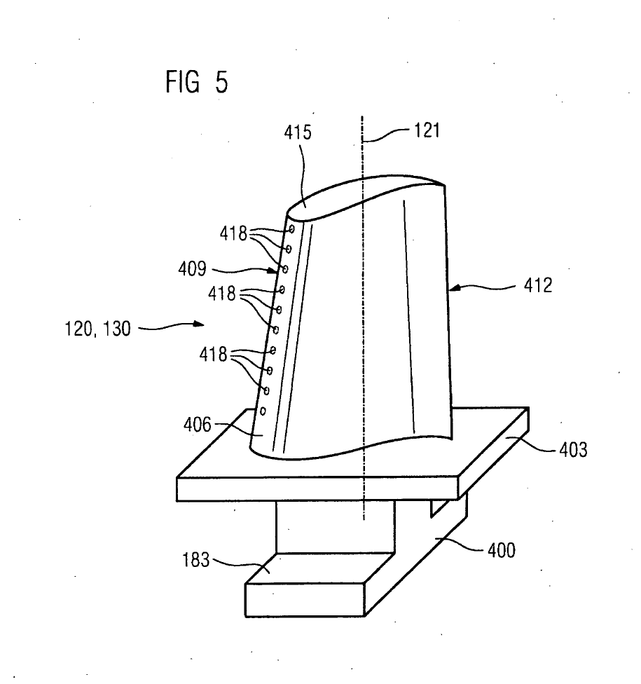

The substrate 4 may be metallic and/or ceramic. Particularly in the case of turbine components, for example turbine rotor blades 120 (FIG. 1) or guide vanes 130 (FIGS. 3, 5), combustion chamber linings 155 (FIG. 4) and other housing parts of a steam or gas turbine 100 (FIG. 3), the substrate 4 consists of a nickel-, cobalt- or iron-based superalloy.

Cobalt-based superalloys are preferably used.

The protective layer 7 according to the invention is placed on the substrate 4.

This protective layer 7 is preferably applied by LPPS (low pressure plasma spraying).

It may be used as an outer layer (not shown) or interlayer (FIG. 1).

In the latter case, there is a ceramic thermal insulation layer 10 on the protective layer 7.

The protective layer 7 may be applied onto newly produced components and refurbished components.

Refurbishment means that components 1 are separated if need be from layers (thermal insulation layer) after their use and corrosion and oxidation products are removed, for example by an acid treatment (acid stripping). It may sometimes also be necessary to repair cracks. Such a component may subsequently be recoated, since the substrate 4 is very expensive.

FIG. 3 shows a gas turbine 100 by way of example in a partial longitudinal section.

The gas turbine 100 internally comprises a rotor 103, which will also be referred to as the turbine rotor, mounted so as to rotate about a rotation axis 102.

Successively along the rotor 103, there are an intake manifold 104, a compressor 105, an e.g. toroidal combustion chamber 110, in particular a ring combustion chamber 106, having a plurality of burners 107 arranged coaxially, a turbine 108 and the exhaust manifold 109.

The ring combustion chamber 106 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fitted on the rotor 103, for example by means of a turbine disk 133. Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110.

From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 106, the guide vanes 130 and rotor blades 120 of the first turbine stage 112, as seen in the flow direction of the working medium 113, are heated the most.

In order to withstand the temperatures prevailing there, they may be cooled by means of a coolant.

The substrates may likewise comprise a directional structure, i.e. they are monocrystalline (SX structure) or comprise only longitudinally directed grains (DS structure).

Iron-, nickel- or cobalt-based superalloys used as the material.

For example, superalloys such as are known from EP 1 204 776 B1, EP 1 306 454, EP 1 319 729 A1, WO 99/67435 or WO 00/44949 are used. With respect to the chemical composition of the superalloys and their advantages, these documents are part of the disclosure.

The blades 120, 130 comprise protective layers 7 according to the invention against corrosion and/or a thermal insulation layer. The thermal insulation layer consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal insulation layer by suitable coating methods, for example electron beam deposition (EB-PVD).

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

FIG. 4 shows a combustion chamber 110 of a gas turbine 100, which may comprise a layer system 1.

The combustion chamber 110 is designed for example as a so-called ring combustion chamber in which a multiplicity of burners 107, arranged in the circumferential direction around the turbine shaft 103, open into a common combustion chamber space. To this end, the combustion chamber 110 as a whole is designed as an annular structure which is positioned around the turbine shaft 103.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M. Each heat shield element 155 is equipped with a particularly heat-resistant protective layer on the working medium side or is made of refractory material and comprises the protective layer 7 according to FIG. 1.

Owing to the high temperatures inside the combustion chamber 110, a cooling system is also provided for the heat shield elements 155 or for their retaining elements.

The materials of the combustion chamber wall and its coatings may be similar to the turbine blades 120, 130.

The combustion chamber 110 is in particular designed in order to detect losses of the heat shield elements 155. To this end, a number of temperature sensors 158 are positioned between the combustion chamber wall 153 and the heat shield elements 155.

FIG. 5 shows a perspective view of a blade 120, 130 which comprises a layer system I with the protective layer 7 according to the invention.

The blade 120, 130 extends along a longitudinal axis 121.

The blade 120, 130 comprises, successively along the longitudinal axis 121, a fastening zone 400, a blade platform 403 adjacent thereto as well as a blade surface zone 406. The protective layer 7 or a layer system 1 according to FIG. 1 is formed particularly in the blade surface zone 406.

A blade root 183 which is used to fasten the rotor blades 120, 130 on the shaft, is formed in the fastening zone 400. The blade root 183 is configured as a hammerhead. Other configurations are possible, for example as a firtree or dovetail root. In conventional blades 120, 130, for example solid metallic materials are used in all regions 400, 403, 406 of the rotor blade 120, 130.

The rotor blade 120, 130 may in this case be manufactured by a casting method, by a forging method, by a machining method or combinations thereof.

1.-20. (canceled)

21. An alloy for a protective layer, comprising: (in wt %)
cobalt in an amount between 26% to 28%;
chromium in an amount between 20% to 22%;
aluminum in an amount between 7% to 9%;
a metal in an amount between 0.5% to 0.7% selected from the group consisting of: yttrium, scandium, rare earth elements and combinations thereof;
optionally,
silicon in an amount up to 2%,
an element in an amount up to 11% selected from the group consisting of rhenium, ruthenium, and combinations thereof; and
remainder nickel.

22. The alloy for a protective layer as claimed in claim 21, further comprising 27 wt % cobalt.

23. The alloy for a protective layer as claimed in claim 22, further comprising 21 wt % chromium.

24. The alloy for a protective layer as claimed in claim 23, containing 0.6 wt % of the equivalent element selected from the group consisting of: yttrium, scandium, the rare earth elements and combinations thereof.

25. The alloy for a protective layer as claimed in claim 24, wherein silicon is present up to 2 wt %.

26. The alloy for a protective layer as claimed in claim 25, wherein silicon is between 1.0 wt % to 2.0 wt %.

27. The alloy for a protective layer as claimed in claim 24, wherein silicon is 0.0 wt %.

28. The alloy for a protective layer as claimed in claim 27, wherein rhenium is 0.0 wt %.

29. The alloy for a protective layer as claimed in claim 27, wherein rhenium is 10 wt %.

30. The alloy for a protective layer as claimed in claim 27, wherein rhenium is 1.5 wt %.

31. The alloy for a protective layer as claimed in claim 30, consisting of nickel, cobalt, chromium, aluminum, yttrium and optionally silicon and/or rhenium.

32. The alloy for a protective layer as claimed in claim 21, wherein yttrium is 0.5 wt % to 0.7 wt %.

33. The alloy for a protective layer as claimed in claim 27, wherein ruthenium is present.

34. The alloy for a protective layer as claimed in claim 27, wherein ruthenium is 0.0 wt %.

35. A protective layer for protecting a gas turbine component against high temperature corrosion or oxidation, comprising (in wt %):
cobalt in an amount between 26% to 28%;
chromium in an amount between 20% to 22%;
aluminum in an amount between 7% to 9%;
a metal in an amount between 0.5% to 0.7% selected from the group consisting of: yttrium, scandium, the rare earth elements and combinations thereof;
optionally,
silicon in an amount up to 2%,
an element in an amount up to 11% selected from the group consisting of rhenium, ruthenium, and combinations thereof; and
remainder nickel.

36. A gas turbine component, comprising:
a component substrate;
a protective layer arranged on the substrate, wherein the protective layer protects the substrate against corrosion and oxygen at high temperatures and comprises:
cobalt in an amount between 26% to 28%,
chromium in an amount between 20% to 22%,
aluminum in an amount between 7% to 9%,
a metal in an amount between 0.5% to 0.7% selected from the group consisting of: yttrium, scandium, the rare earth elements and combinations thereof,
optionally,
silicon in an amount up to 2%,
an element in an amount up to 11% selected from the group consisting of rhenium, ruthenium, and combinations thereof; and
remainder nickel.

37. The component as claimed in claim 36, wherein a ceramic thermal insulation layer is applied on the protective layer.

38. The component as claimed in claim 37, wherein the substrate of the component is a nickel-based alloy.

39. The component as claimed in claim 37, wherein the substrate of the component is a cobalt-based alloy.
